(19) United States
(12) Patent Application Publication
(10) Pub. No.: US 2014/0310035 A1
(43) Pub. Date: Oct. 16, 2014

(54) METHOD FOR SOLVING PROBLEMS

(71) Applicants: Reinout Declerck, Gent (BE); Francois Crop, Wezembeek-Oppem (BE)

(72) Inventors: Reinout Declerck, Gent (BE); Francois Crop, Wezembeek-Oppem (BE)

(21) Appl. No.: 14/219,610

(22) Filed: Mar. 19, 2014

Related U.S. Application Data
(60) Provisional application No. 61/803,475, filed on Mar. 20, 2013.

(51) Int. Cl. G06Q 10/06

(52) U.S. Cl. CPC G06Q 10/063
USPC 705/7.11

(57) ABSTRACT

The present invention concerns a computer-implemented method, for solving a problem for a user.

### FIELD OF THE INVENTION

The present invention is in the field of computer-implemented methods for solving problems within an organization.

### BACKGROUND TO THE INVENTION

Every day, millions of people face business problems in their professional environment, from very strategic problems (such as “Should we acquire a competitor or grow organically by opening a sales office in Asia?”) to management problems (such as “How to improve team morale in my team?”) to operational/technical problems (such as “Why do we have so many unplanned stops on this production line?”). Many of these problems require specific methodology and knowledge to be efficiently and correctly solved. The required methodology and knowledge are not always available to the individual(s) facing the problem.

Problem solving often uses generic or ad hoc methods, in an orderly manner (“steps”), for finding solutions to problems. Problem solving is used, for instance, in engineering when products or processes fail, so corrective action can be taken to prevent further failures. 8 Disciplines Problem Solving (8D) is a popular example of a problem solving method. The disciplines are:
D0: Plan
D1: Use a Team
D2: Define and describe the Problem
D3: Develop Interim Containment Plan
D4: Determine, Identify, and Verify Root Causes and Escape Points
D5: Choose and Verify Permanent Corrections (PCs) for Problem/Non Conformity
D6: Implement and Validate Corrective Actions
D7: Take Preventive Measures
D8: Congratulate Your Team

Today, the options to gather the required methodology and knowledge for a given problem are limited, and all have limitations:
Ask colleagues around for help. However, organizations are constantly evolving, and finding the right expertise within an organization can be extremely difficult.
Search through internal documents, business literature, the World Wide Web, etc. This can be a daunting and very time-consuming task. As with all searches, it is impossible to know upfront whether the search will yield interesting information. Information found is often not directly applicable to the present problem.
Reach out to external advisors (consultants). However, organizations cannot afford to call consultants for every business problem.

On top, new expertise gathered while solving a problem is often insufficiently captured by and distributed throughout the organization. When a similar problem arises elsewhere in the organization, it is likely that the people involved will start a problem solving effort from scratch, whereas they could have learned from earlier experience.

As a result, people often lose a lot of time (look for information, reinvent the wheel, etc.) and/or take ill-informed decisions (rely on hunches, incorrect reasoning, etc.), which negatively affects the bottom-line of their organization. This is often even more true in larger organizations, where the complexity of organizational structure and processes aggravate the above observations.

Therefore, it is an object of the invention to provide a more efficient method for solving problems. It is also an object of the invention to provide a method for solving problems that avoids similar problems from reoccurring in the future.

### SUMMARY OF SOME EMBODIMENTS OF THE INVENTION

The objects stated above are fully or partially attained by the present invention and preferred embodiments thereof.

In a first aspect, the invention relates to a method, system or programs to solve business problems, comprising functionality to structure a problem into smaller sub-problems and follow a logical process to solve a problem, suggest methodology and knowledge aspects from previous and other similar business problems, monitor key performance indicators around the volume and efficiency of problem solving within an organization including the completion of pending actions, push problems and their associated solutions and/or actions to everyone in the organization that may encounter similar problems.

In a second aspect, the invention relates to a computer-implemented method, for solving a problem for a user by a computer system, preferably wherein the computer system comprises a client (2) and a server (3), the method comprising the steps of:
a) receiving a project from the user, wherein the project is based on a problem encountered by the user;
b) receiving a context of the problem from the user;
c) dividing the problem into one or more sub-problems and/or receiving a division of the problem into one or more sub-problems from the user, thereby creating one or more nodes;
d) optionally, defining one or more experts and/or receiving one or more experts from the user, and assigning the one or more experts to the problem or to one or more sub-problems and/or receiving an assignment of the one or more experts to the problem or to one or more sub-problems from the user;
e) finding causes of and/or solutions to the one or more sub-problems, and/or receiving causes of and/or solutions to the one or more sub-problems from the assigned experts or from the user;
f) defining the found solutions for the one or more sub-problems, and/or receiving a definition of the found solutions for the one or more sub-problems from the assigned experts or from the user;
g) optionally, receiving verification of the results of the found solutions for the one or more sub-problems from the assigned experts or from the user; and
h) storing the context of step b), the division of step c), the assignment of experts of step d), the causes and/or solutions of step e), the defined found solutions of step f) and/or the verification of results of step g) in a database.

In a third aspect, the invention relates to a computer-implemented method, for solving a problem for a user using a computer system, preferably wherein the computer system comprises a client (2) and a server (3), the method comprising the steps of:
a′) providing a project, wherein the project is based on a problem encountered by the user;
b′) providing a context of the problem;
c′) dividing the problem into one or more sub-problems and/or receiving a division of the problem into one or more sub-problems from a computer system, thereby creating one or more nodes;
d′) optionally, defining one or more experts and/or receiving one or more experts from the computer system, and assigning the one or more experts to the problem or to one or more sub-problems and/or receiving an assignment of the one or more experts to the problem or to one or more sub-problems from the computer system;
e′) finding causes of and/or solutions to the one or more sub-problems, and/or receiving causes of and/or solutions to the one or more sub-problems from the computer system or from the assigned experts;
f′) defining the found solutions for the one or more sub-problems, and/or receiving a definition of the found solutions for the one or more sub-problems from the computer system or from the assigned experts;
g′) optionally, verifying the results of the found solutions for the one or more sub-problems; and
h′) storing the context of step b), the division of step c), the assignment of experts of step d), the causes and/or solutions of step e), the defined found solutions of step f) and/or the verification of results of step g) in a database on the computer system.

Although often represented as a sequence above, it may be possible for the user or an expert to re-order the steps, or to go back to a certain step.

In some preferred embodiments, the invention relates to a method according to the first aspect of the invention, or to a computer-implemented method according to the second or third aspect of the invention, wherein step c) or c′) comprises splitting up the problem and optionally one or more sub-problems into sub-problems using a hierarchical tree-like structure comprising one or more nodes.

In some preferred embodiments, the invention relates to a method according to the first aspect of the invention, or to a computer-implemented method according to the second or third aspect of the invention, wherein step c) or c′) is performed manually by the user, automatically by the computer system, or manually by the one or more experts, for example based on a request from the user.

In some preferred embodiments, the invention relates to a method according to the first aspect of the invention, or to a computer-implemented method according to the second or third aspect of the invention, wherein step d) or d′) comprises the addition of one or more individual experts and/or the addition of one or more communities comprising one or more individual experts.

In some preferred embodiments, the invention relates to a method according to the first aspect of the invention, or to a computer-implemented method according to the second or third aspect of the invention, wherein the one or more individual experts and/or the one or more communities are selected based on their expertise with regards to the sub-problems to which they are assigned.

In some preferred embodiments, the invention relates to a method according to the first aspect of the invention, or to a computer-implemented method according to the second or third aspect of the invention, wherein step e) or e′) comprises performing an investigative action and providing evidence as an output of the investigative action.

In some preferred embodiments, the invention relates to a method according to the first aspect of the invention, or to a computer-implemented method according to the second or third aspect of the invention, wherein step e) or e′) comprises the generation of automatic suggestions selected from solutions stored on the database.

In some preferred embodiments, the invention relates to a method according to the first aspect of the invention, or to a computer-implemented method according to the second or third aspect of the invention, wherein the automatic suggestions are selected from information previously stored on the database in step h) or h′) performed for a previous problem.

In some preferred embodiments, the invention relates to a method according to the first aspect of the invention, or to a computer-implemented method according to the second aspect of the invention, comprising the steps of:
i) selecting of one or more nodes;
ii) testing one or more nodes within one or more previously solved problems or sub-problems in the database for matching characteristics with the selected one or more nodes;
iii) assigning a matching score based on the amount and type of matching characteristics in step ii);
iv) selecting the one or more nodes within one or more previously solved problems or sub-problems with the highest matching scores; and
v) proposing the one or more underlying nodes who may or may not be grouped, the one or more associated experts, and/or the one or more associated information sources, for example documents, videos, images of the one or more nodes within one or more previously solved problems or sub-problems selected in iv) as suggestions, for example as a list.

In some preferred embodiments, the invention relates to a method according to the first aspect of the invention, or to a computer-implemented method according to the third aspect of the invention, wherein comprising the steps of:
v′) receiving a proposal of the one or more underlying nodes who may or may not be grouped, the one or more associated experts, and/or the one or more associated information sources, for example documents, videos, images, of one or more nodes within one or more previously solved problems or sub-problems as suggestions, for example as a list, from the computer system; and
vi′) selecting one or more proposals received in step v′); and
vii′) adding the selected one or more proposals as a cause or solution to one or more sub-problems.

In some preferred embodiments, the invention relates to a method according to the first aspect of the invention, or to a computer-implemented method according to the second or third aspect of the invention, wherein step f) or f′) comprises defining a set of corrective and/or preventive actions to fix the problem and/or to prevent reoccurrence.

In some preferred embodiments, the invention relates to a method according to the first aspect of the invention, or to a computer-implemented method according to the second or third aspect of the invention, wherein step h) or h′) comprises defining a stored solution as “best practice” for handling similar problems.

In some preferred embodiments, the invention relates to a method according to the first aspect of the invention, or to a computer-implemented method according to the second or third aspect of the invention, wherein the database in step h) or h′) is updated in real-time.

In some preferred embodiments, the invention relates to a method according to the first aspect of the invention, or to a computer-implemented method according to the second or third aspect of the invention, further comprising the step of computing performance indicators based on the database in step h) or h′).

In some preferred embodiments, the invention relates to a method according to the first aspect of the invention, or to a computer-implemented method according to the second or third aspect of the invention, wherein the problem is a strategic problem or a management problem.

In some preferred embodiments, the invention relates to a method according to the first aspect of the invention, or to a computer-implemented method according to the second or third aspect of the invention, wherein the problem is an operational or technical problem.

In some preferred embodiments, the invention relates to a method according to the first aspect of the invention, or to a computer-implemented method according to the second or third aspect of the invention, wherein the problem is an engineering problem.

In a fourth aspect, the invention relates to a computer program, or a computer program product directly loadable into the internal memory of a computer, or a computer program product stored on a computer readable medium, or a combination of such computer programs or computer program products, configured for performing the method according to the first, second, or third aspect of the invention.

In a fifth aspect, the invention relates to a computer system, preferably comprising a server, comprising the database generated in step h) or h′) by the method of the second or third aspect of the invention.

The methods according to the invention have the advantage that a problem is structured by breaking it down into smaller components, which are individually easier to investigate. Furthermore, the methods according to the invention foster collaboration when it matters most, i.e. when a problem needs to be tackled, and identify the people that are ideally suited to address the challenge at hand. By repeatedly applying the methods according to the invention, the database becomes larger, and the methods become more efficient. The more problems an organization is faced with, the better the organization becomes in solving new problems.

### FIGURE LEGENDS

FIG. 1 shows a typical set-up, comprising a Server (3) and one or more Client (2) computers.

FIG. 2 presents an example embodiment of View I: the User (1) starts a new business problem (“How to turnaround my business?”), specifies the context of this problem and adds other Users who are involved in or may have an interest in this problem and its solutions and/or actions (right-hand side).

FIG. 3 presents an example embodiment of View I: the User (1) breaks the overall problem up in smaller sub-problems using a tree-like structure, and attaches an information element (in this case, a document) to a Node, i.e. an element of the tree.

FIG. 4 presents an example embodiment of View I: the Server (3) suggests a collection of key variables (right-hand side) that influence the sub-problem the User (1) has currently selected (“Expand business scope”). The User (1) can choose to integrate this suggestion into the current problem.

FIG. 5 presents an example embodiment of View I: the Server (3) suggests two Experts (right-hand side) that are knowledgeable about the sub-problem the User (1) has currently selected (“Expand business scope”). The User (1) can contact the Experts to help him on the current problem.

FIG. 6 presents an example embodiment of View I: the Server (3) suggests a document (right-hand side) relevant for the sub-problem the User (1) has currently selected (“Expand business scope”). The User (1) can choose to integrate this suggestion into the current business problem.

FIG. 7 presents an example embodiment of View I: the User (1) specifies a conclusion about each node of the tree. Some nodes have a concrete improvement opportunity, whereas others don't (“No improvement potential”).

FIG. 8 presents an example embodiment of View I: the User (1) defines a set of actions (right-hand side) to realize the conclusions.

FIG. 9 presents an example embodiment of View II.

FIG. 10 presents an example embodiment of View Ill.

FIG. 11 presents an example embodiment of the Server (3) database layout.

FIG. 12 displays the different attributes of a Node in a tree-like structure.

FIG. 13 displays a step-by-step procedure to solve a problem according to a preferred embodiment of the invention.

FIG. 14 displays a step-by-step procedure illustrating how suggestions may be automatically generated from a database while solving a new problem.

### DETAILED DESCRIPTION OF THE INVENTION

Before the present methods of the invention are described, it is to be understood that this invention is not limited to particular methods or combinations described, since such methods and combinations may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all numbers and fractions subsumed within the respective ranges, as well as the recited endpoints.

Whereas the terms “one or more” or “at least one”, such as one or more or at least one member(s) of a group of members, are clear per se, by means of further exemplification, the terms encompass inter alia a reference to any one of said members, or to any two or more of said members, such as, e.g., any ≧3, ≧4, ≧5, ≧6 or ≧7 etc. of said members, and up to all said members.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

In the present description of the invention, reference is made to the accompanying drawings that form a part hereof, and in which are shown by way of illustration only of specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention concerns a method, system and programs to solve problems encountered in a business or industrial setting efficiently, comprising one or more of following functionalities:
Functionality to structure a problem ‘top-down’, i.e. starting with the big picture, and then iteratively breaking it down into smaller segments (sub-problems).
Functionality to follow a logical process to solve a problem: Problem definition: “What is the main question? What are the key variables that have an influence on my problem?”
Analysis: “What influence does each variable have in the overall problem?” Conclusions/Actions: “Given the influence of each variable, what are the possible solutions?”; “Which actions should be implemented to enable this?”
Functionality that provides suggestions (key variables of a problem, experts, documents, etc.) all along the problem solving process. These suggestions are preferably drawn from all previously solved business problems. These suggestions are preferably contextual, i.e. they take into account the context of the problem; not only the context of the global problem, but also the context of the specific sub-problem that an individual is trying to solve.
Functionality that allows to monitor key performance indicators around the volume and efficiency of problem solving within the organization, including the completion of pending actions.
Functionality to push problems and their associated solutions and/or actions to everyone in the organization that may encounter similar problems.

FIG. 13 displays a step-by-step procedure to solve a problem according to a preferred embodiment of the invention.

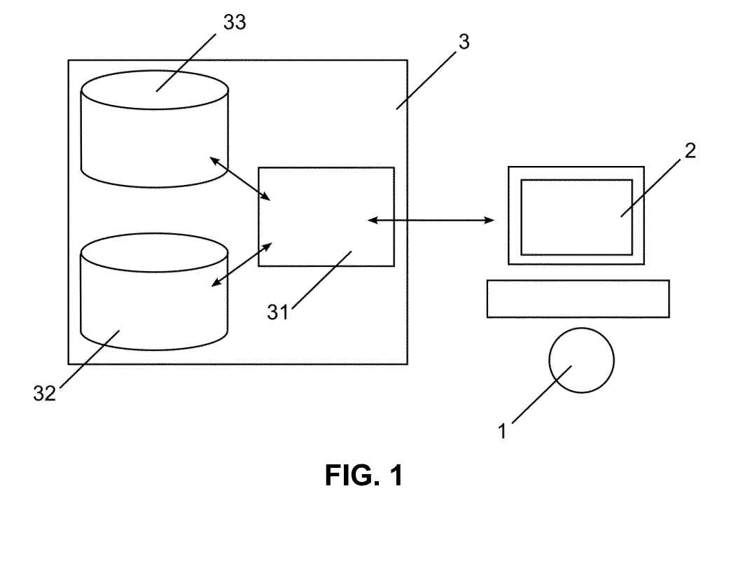

The computer system in a typical set-up uses a client-server model, which is a distributed application structure that partitions tasks or workloads between the providers of a resource or service, called Servers, and service requesters, called Clients, as shown in FIG. 1. Preferably, the computer system comprises at least one Client (2) and a Server (3). The Client (2) may be connected to the Server (3) by any means, but is preferably connected to the Server (3) using a world-wide-web protocol. Computers used to host the computer system can be (but are not limited to) desktop computers, laptops, tablets and smartphones. In a preferred embodiment, Server (3) and Client (2) communicate with each other via a network. The Client (2) is operated by a User (1). The Server's main role is to process, store and retrieve information provided by Users (1), whereas the Client's main role is to process and display information. The Client (2) may employ a user-interface provided by a web browser. The Server (3) preferably comprises a database. As shown in FIG. 1, the Server (3) may comprise an information processing unit (31), and one or more databases (32,33), such as a database (32) of Users and/or problems and a database (33) of suggestions.

In some embodiments, the Client (2) has three main views: a view to manipulate a problem (View I), a view to navigate through (groups of) problems (View II), and a view to monitor indicators around problem solving and to follow up on actions (View III). These views may be accessible from a User (1) home page.

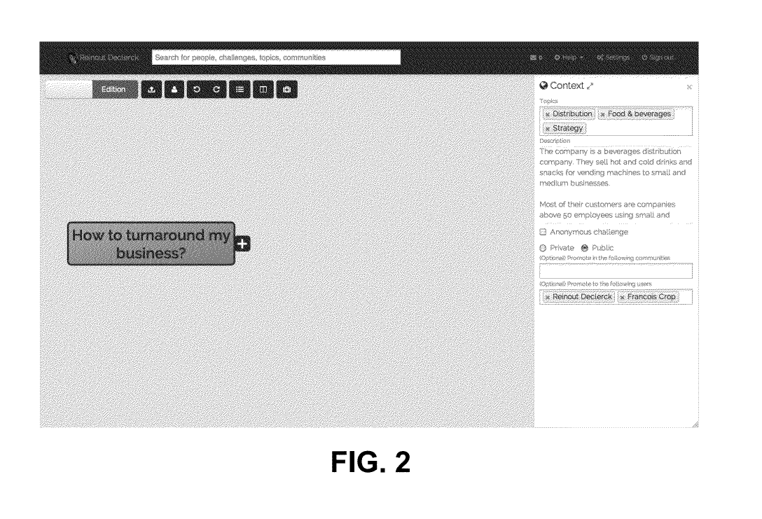

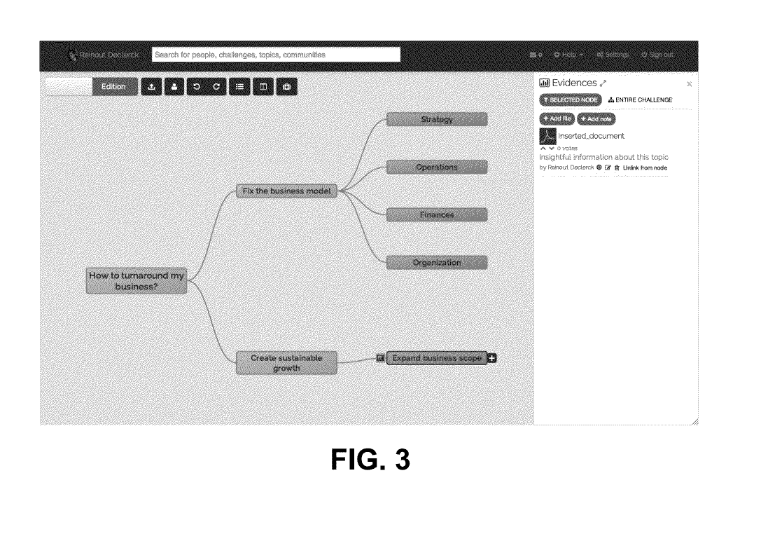

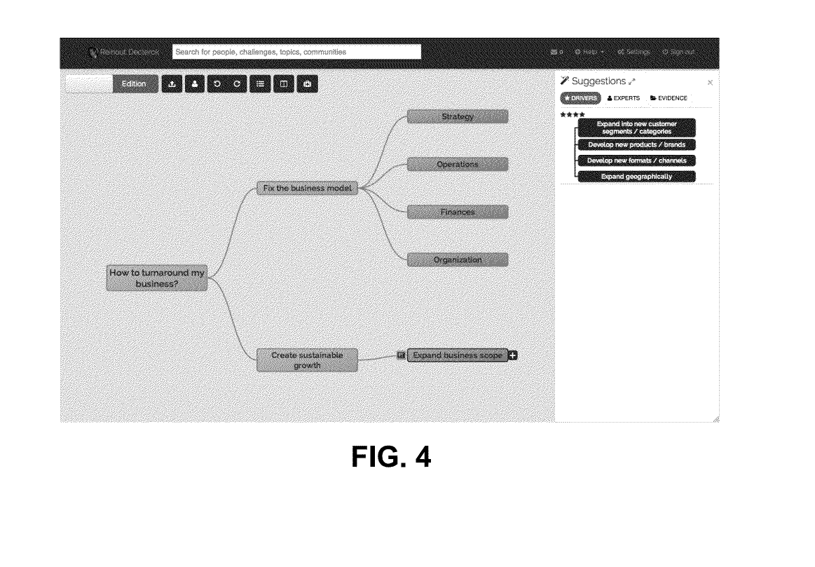

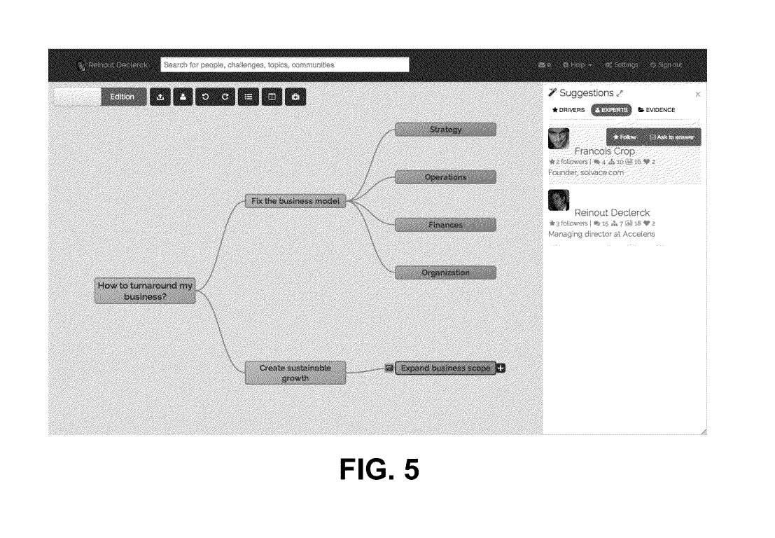

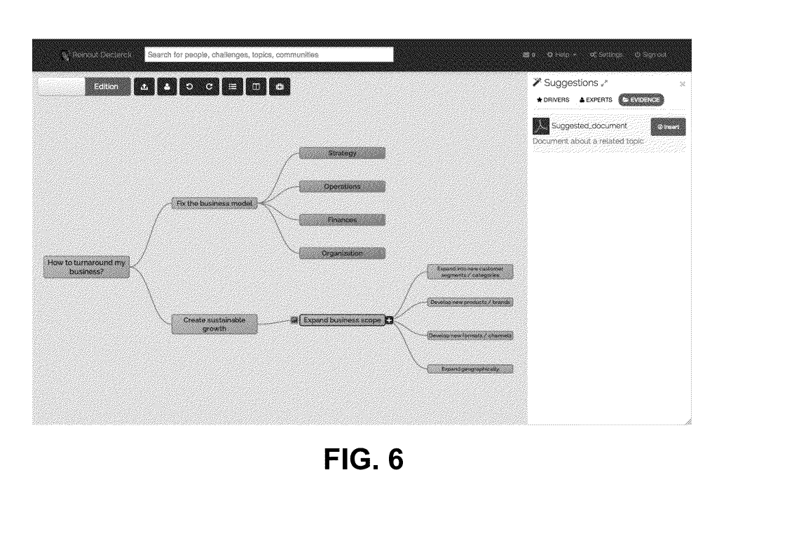

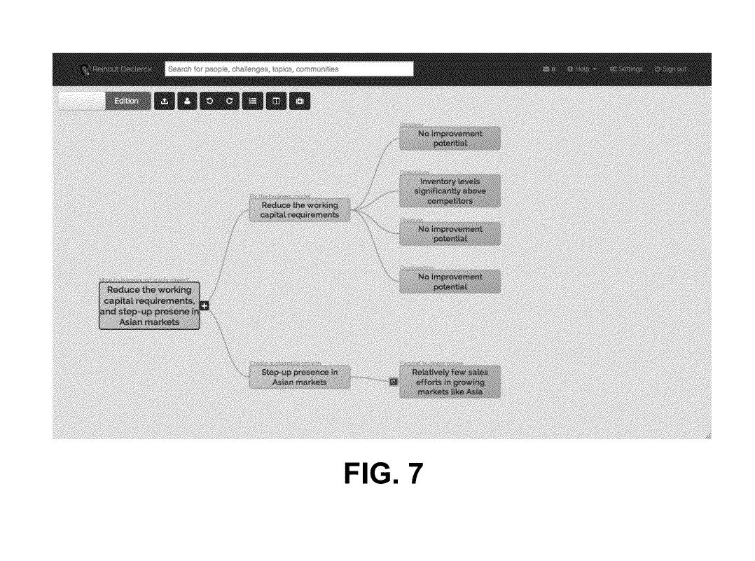

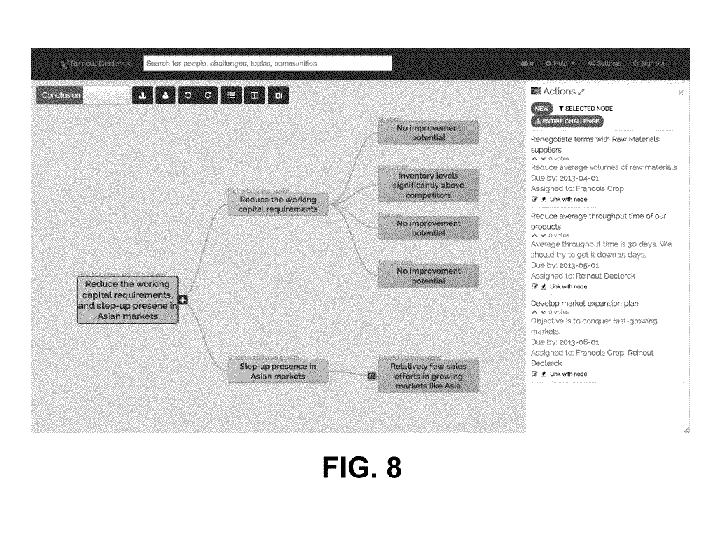

View I (FIGS. 2-8) comprises an area, in which the User (1) can define a problem. A new project can, for example, be created through a button on the User's home page. One or more forms may be provided to input one or more keywords related to the problem, to specify the context of the problem, to describe the history of the problem, or to provide criteria under which the problem is considered solved. The keywords may be used to search for related problems or sub-problems from previous projects.

Using an ordered structure such as a tree (tree-like structure) comprising one or more nodes, the User (1) can first break the problem up into smaller sub-problems, each of which may be individually easier to address. Then, for each sub-problem, the User (1) can include information specific to that sub-problem.

There may be several node types:
Driver.

These are structure elements that have an influence on the key question that is answered. For example “Increase revenues” is a driver for an “How to increase profitability” problem. In some embodiments, drivers are indexed by the suggestion engine. Another example of drivers are the potential causes of a problem. For example “Snow on the road” is a possible driver (cause) for the “Why did I arrive late at work?” problem.
Category.

Category nodes are dividers that are preferably not indexed by a suggestion engine. For example, “Business unit A” and “Business unit B” can be categories as they do not provide deeper insight and are just here to organize the structure of the analysis.
Recommendation.

Recommendations answer the question: “what should I do?”, and are preferably indexed by a suggestion engine. For example, “Stop smoking” and “Exercise” are recommendation nodes for a “Healthy life” node.
Special case: “Root cause” flag.

The root cause flag is not a node type per se, it is just a flag that applies to driver nodes, and that identifies the selected node as a likely root cause of the problem.

When all the nodes of a problem's structure have been analyzed and scored, the User (1) has created a heat map for the problem, allowing him to flag the root causes with a distinctive color.

In some embodiments, the Client (2) displays suggested information elements that have been used in similar problems for each sub-problem, and displays suggested individuals which have worked on similar problems (Experts). These suggestions can be generated by the Server (3). The User (1) can include the suggested information elements into the problem currently being manipulated, and/or communicate with the Experts. The User (1) can add Experts or entire communities of Experts to the problem, for example through a form. The Experts may work simultaneously on a problem or sub-problem. In some embodiments, all Experts have full read and write access. In some embodiments, some of the Experts are Followers, and have only read access. In some embodiments, some Followers have read and restricted write access, for example in a feedback panel.

To identify the root cause(s) of a problem, the User (1) or Expert may analyze each node of a problem's structure. An analysis typically comprises one or more investigative actions, which assess the influence of the node in the overall problem. The output of an investigative action can be an evidence (a document, a video, a note, etc.), which summarizes the findings of the analysis, and allows the User (1) to give an influence score for the node.

The result of each sub-problem in the tree-like structure can be a conclusion, i.e. a statement on the basis of the provided information elements of what the sub-problem means for the overall problem. From the conclusions for a group of sub-problems, a conclusion can be drawn about the parent (sub-)problem, and so on. By working his way up in the tree-like structure, the User (1) may generate a set of conclusions which allow reaching an overall conclusion. Finally, the User (1) can define one or more actions that must be carried out to solve the problem. These actions can be sequenced in time and assigned to an action owner, which can be the User (1) himself or other Users or groups thereof. When the problem is solved, a notification can be sent to everyone in the organization who could be interested in this problem and its solutions and/or actions.

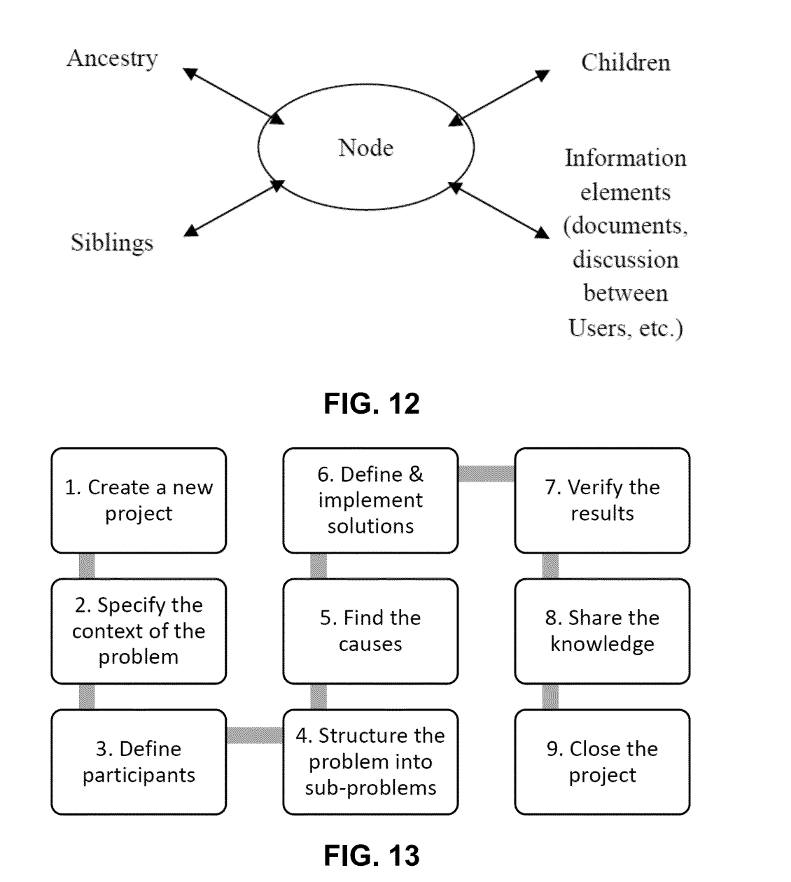

As an example, to generate the suggestions described in View I, the Server (3) may analyze (amongst others) the collective set of information from previous business problems, as follows:
Each problem is defined through a tree-like structure, in which each element (Node) represents a sub-problem of the overall problem. Information elements (documents, discussion between Users, etc.) are often related to one or more Nodes.
From the perspective of an individual Node, each Node can have an ancestry (parent problems), siblings (sub-problems of the same parent problem), children (sub-problems), and/or information elements linked with it (see FIG. 12).
The Server (3) tests all Nodes within all previous problems for matching characteristics with the selected Node of the current business problem: similar name, ancestry, siblings, children, information elements, etc. The similarity is tested for example through semantic similarity techniques and/or machine-learning techniques. Candidate Nodes receive a higher matching score if they have more matching characteristics.
The Server (3) sends characteristics from the highest scoring Candidate Nodes as suggestions to the Client (2): key variables of a (sub-)problem, experts, documents, etc.

The suggestions are preferably provided in real-time and are preferably highly specific to what the User (1) is currently doing (e.g. through detection of selected text). The suggestions can be generated through several machine-learning techniques, such as, but not limited to, collaborative filtering, content-based similarity, pattern recognition, information clustering, and social verification

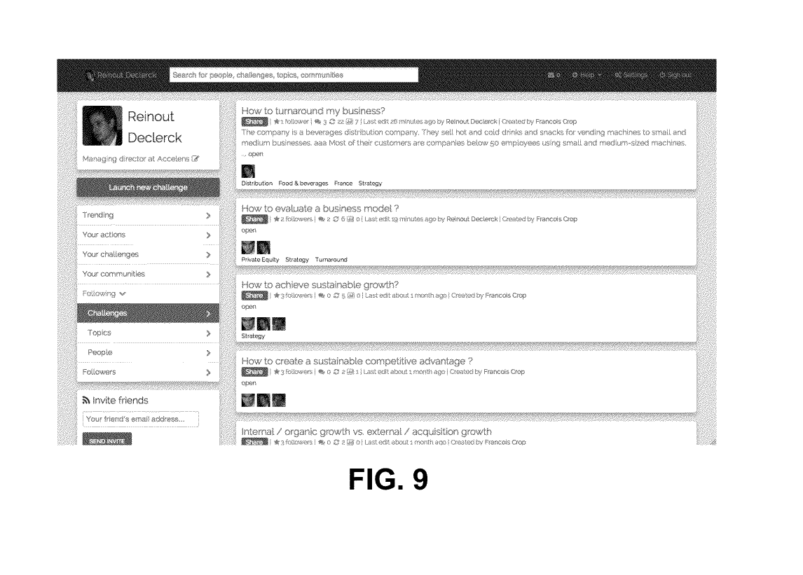

View II (FIG. 9) displays a list of problems, for example business problems, that are sorted (amongst others) based on the User's role in the organization and the User's expressed interests. Each problem is represented by a description of the problem and its solution if available. For each problem, the User (1) can request to display View I. The User (1) can search for specific problems, for example by entering search queries or by narrowing the list of problems to certain topics, communities, etc. A User (1) can indicate his interest in certain topics, communities, etc. which updates the User's expressed interests.

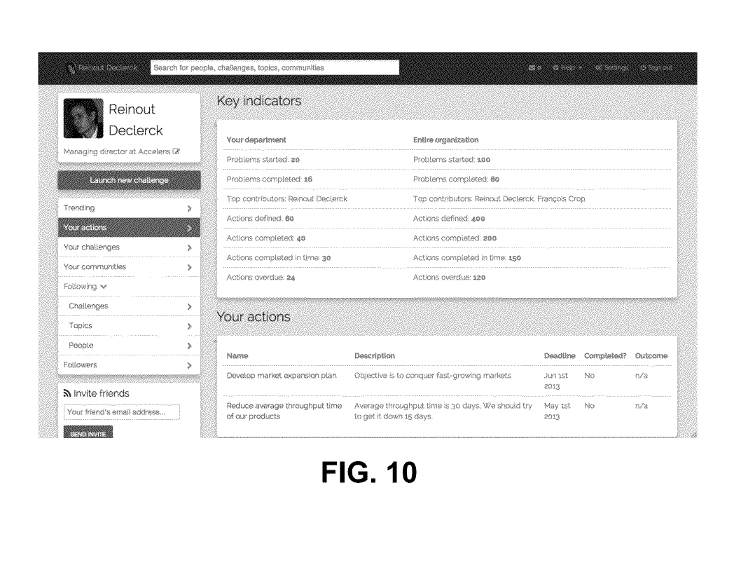

View III (FIG. 10) displays the User's pending and completed actions, as well as key performance indicators around the volume and efficiency of problem solving within the organization and certain subsections of the organization. The User (1) can indicate that specific actions have been completed, and can indicate whether the actions had the desired outcome.

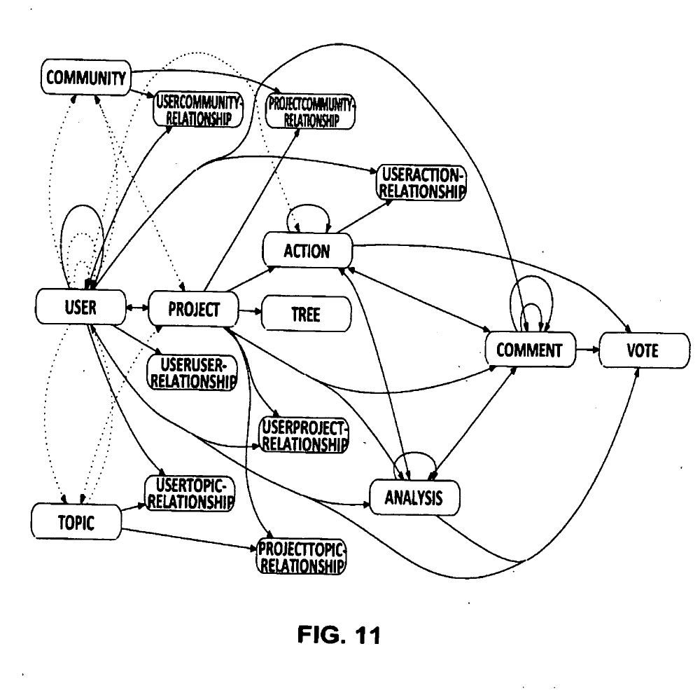

In some embodiments, the Server (3) stores all or part of the information provided by the User (1) in a database. An example embodiment of such a database is described by an entity-relationship diagram in FIG. 11.

In some preferred embodiments, every problem or sub-problem previously solved by the method according to the invention, is stored in the database. This database, which may contain a growing set of solved problems, can be used to automatically deduct real-time suggestions when a new problem is being solved. These suggestions enable an efficient re-use of knowledge and expertise. Suggestions can be:
Structure elements: key variables of a problem. For instance, Revenues and Costs are key variables of Profit; Fixed costs and Variable costs are key variables of Costs
Experts: Other users knowledgeable about the new problem, because of their past contributions to similar problems
Documents: Useful documents which were used in similar problems.

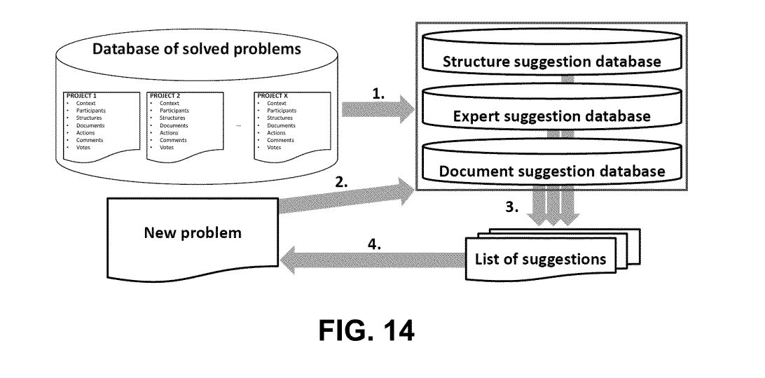

FIG. 14 displays a step-by-step procedure illustrating how suggestions may be automatically generated from a database while solving a new problem. The method may comprise following steps:
1) regularly refreshing the suggestion databases based on the latest database of solved problems, and other sources;
2) sending the context and the current position in the problem structure of a new problem;
3) generating a list of suggestions and displaying it to the User (1); and
4) importing a suggestion by the User (1), and adding it into the new problem.

In some preferred embodiments, the database further serves as a source of information to generate performance indicators around the volume and efficiency of problem solving within the organization. Performance indicators may be user indicators (e.g. “Who contributed the most?”), project indicators (e.g. “What are the problems that are currently being worked on in the company?”), and action indicators (e.g. “What is the percentage of actions completed on-time?”).

In some embodiments, the User (1) defines a set of corrective and preventive actions to fix the problem and prevent reoccurrence. Actions can be assigned to one or more action owners, and positioned in time with start dates and deadlines. Action owners can be reminded via email of upcoming deadlines. In some embodiments, problem responsibles may be assigned (e.g. the User (1)) and they may regularly receive a report on the progress of actions within their problem. The actions may comprise details selected from: name, description, actors, start date, deadline, impact (helps to prioritize actions), feasibility (helps to prioritize actions), priority (identify high priority actions that must be performed first. Each action actor may report his progress (for example on a slider from 0 to 100%), and can indicate an outcome and comments.

In some embodiments, the database stored on the Server (3) may be explored to find and study similar problems and their respective solutions.

1. A computer-implemented method, for solving a problem for a user (1) by a computer system, preferably wherein the computer system comprises a client (2) and a server (3), the method comprising the steps of:
a) receiving a project from the user (1), wherein the project is based on a problem encountered by the user (1);
b) receiving a context of the problem from the user (1);
c) dividing the problem into one or more sub-problems and/or receiving a division of the problem into one or more sub-problems from the user (1), thereby creating one or more nodes;
d) optionally, defining one or more experts and/or receiving one or more experts from the user (1), and assigning the one or more experts to the problem or to one or more sub-problems and/or receiving an assignment of the one or more experts to the problem or to one or more sub-problems from the user (1);
e) finding causes of and/or solutions to the one or more sub-problems, and/or receiving causes of and/or solutions to the one or more sub-problems from the assigned experts or from the user (1);
f) defining the found solutions for the one or more sub-problems, and/or receiving a definition of the found solutions for the one or more sub-problems from the assigned experts or from the user (1);
g) optionally, receiving verification of the results of the found solutions for the one or more sub-problems from the assigned experts or from the user (1); and
h) storing the context of step b), the division of step c), the assignment of experts of step d), the causes and/or solutions of step e), the defined found solutions of step f) and/or the verification of results of step g) in a database.

2. A computer-implemented method, for solving a problem by a user (1) using a computer system, preferably wherein the computer system comprises a client (2) and a server (3), the method comprising the steps of:
a′) providing a project, wherein the project is based on a problem encountered by the user (1);
b′) providing a context of the problem;
c′) dividing the problem into one or more sub-problems and/or receiving a division of the problem into one or more sub-problems from a computer system, thereby creating one or more nodes;
d′) optionally, defining one or more experts and/or receiving one or more experts from the computer system, and assigning the one or more experts to the problem or to one or more sub-problems and/or receiving an assignment of the one or more experts to the problem or to one or more sub-problems from the computer system;
e′) finding causes of and/or solutions to the one or more sub-problems, and/or receiving causes of and/or solutions to the one or more sub-problems from the computer system or from the assigned experts;
f′) defining the found solutions for the one or more sub-problems, and/or receiving a definition of the found solutions for the one or more sub-problems from the computer system or from the assigned experts;
g′) optionally, verifying the results of the found solutions for the one or more sub-problems; and
h′) storing the context of step b), the division of step c), the assignment of experts of step d), the causes and/or solutions of step e), the defined found solutions of step f) and/or the verification of results of step g) in a database on the computer system.

3. Method according to claim 1 or 2, wherein step c) or c′) comprises splitting up the problem and optionally one or more sub-problems into sub-problems using a hierarchical tree-like structure comprising one or more nodes.

4. Method according to any of claims 1 to 3, wherein step c) or c′) is performed manually by the user (1), automatically by the computer system, or manually by the one or more experts, for example based on a request from the user (1).

5. Method according to any of claims 1 to 4, wherein step d) or d′) comprises the addition of one or more individual experts and/or the addition of one or more communities comprising one or more individual experts.

6. Method according to claim 5, wherein the one or more individual experts and/or the one or more communities are selected based on their expertise with regards to the sub-problems to which they are assigned.

7. Method according to any of claims 1 to 6, wherein step e) or e′) comprises performing an investigative action and providing evidence as an output of the investigative action.

8. Method according to any of claims 1 to 7, wherein step e) or e′) comprises the generation of automatic suggestions selected from solutions stored on the database.

9. Method according to claim 8, wherein the automatic suggestions are selected from information previously stored on the database in step h) or h′) performed for a previous problem.

10. Method according to claim 1 in combination with claim 8 or 9, comprising the steps of:
i) selecting one or more nodes;
ii) testing one or more nodes within one or more previously solved problems or sub-problems in the database for matching characteristics with the selected one or more nodes;
iii) assigning a matching score based on the amount and type of matching characteristics in step ii);
iv) selecting the one or more nodes within one or more previously solved problems or sub-problems with the highest matching scores; and
v) proposing the one or more underlying nodes who may or may not be grouped, the one or more associated experts, and/or the one or more associated information sources, for example documents, videos, images of the one or more nodes within one or more previously solved problems or sub-problems selected in iv) as suggestions, for example as a list.

11. Method according to claim 2 in combination with claim 8 or 9, comprising the steps of:
v′) receiving a proposal of the one or more underlying nodes who may or may not be grouped, the one or more associated experts, and/or the one or more associated information sources, for example documents, videos, images, of one or more nodes within one or more previously solved problems or sub-problems as suggestions, for example as a list; and
vi′) selecting one or more proposals received in step v′) by the user (1); and
vii′) adding the selected one or more proposals as a cause or solution to one or more sub-problems.

12. Method according to any of claims 1 to 11, wherein step f) or f′) comprises defining a set of corrective and/or preventive actions to fix the problem and/or to prevent reoccurrence.

13. Method according to any of claims 1 to 12, wherein step h) or h′) comprises defining a stored solution as “best practice” for handling similar problems.

14. Method according to any of claims 1 to 13, wherein the database in step h) or h′) is updated in real-time.

15. Method according to any of claims 1 to 14, further comprising the step of computing performance indicators based on the database in step h) or h′).

16. Method according to any of claims 1 to 15, wherein the problem is a strategic problem or a management problem.

17. Method according to any of claims 1 to 15, wherein the problem is an operational or technical problem.

18. Method according to claim 17, wherein the problem is an engineering problem.

19. A computer program, or a computer program product directly loadable into the internal memory of a computer, or a computer program product stored on a computer readable medium, or a combination of such computer programs or computer program products, configured for performing the method according to any of claims 1 to 18.

20. A computer system, preferably comprising a server (3), comprising the database generated in step h) or h′) by the method of any of claims 1 to 19.

21. A method to solve business problems, comprising functionality to structure a problem into smaller sub-problems and follow a logical process to solve a problem, suggest methodology and knowledge aspects from previous and other similar business problems, monitor key performance indicators around the volume and efficiency of problem solving within an organization including the completion of pending actions, push problems and their associated solutions and/or actions to everyone in the organization that may encounter similar problems.

22. A system to solve business problems, comprising functionality to structure a problem into smaller sub-problems and follow a logical process to solve a problem, suggest methodology and knowledge aspects from previous and other similar business problems, monitor key performance indicators around the volume and efficiency of problem solving within an organization including the completion of pending actions, push problems and their associated solutions and/or actions to everyone in the organization that may encounter similar problems.

23. Programs to solve business problems, comprising functionality to structure a problem into smaller sub-problems and follow a logical process to solve a problem, suggest methodology and knowledge aspects from previous and other similar business problems, monitor key performance indicators around the volume and efficiency of problem solving within an organization including the completion of pending actions, push problems and their associated solutions and/or actions to everyone in the organization that may encounter similar problems.
